(19) United States
(12) Patent Application Publication
(10) Pub. No.: US 2021/0140906 A1
(43) Pub. Date: May 13, 2021

(54) NANOCHANNEL-BASED SENSOR CALIBRATION

(71) Applicant: FemtoDx, Beverly Hills, CA (US)

(72) Inventors: Sudhakar Pamarti, Irvine, CA (US); Shyamsunder Erramilli, Quincy, MA (US); Pritiraj Mohanty, Los Angeles, CA (US)

(73) Assignee: FemtoDx, Beverly Hills, CA (US)

(21) Appl. No.: 16/773,041

(22) Filed: Jan. 27, 2020

Related U.S. Application Data
(60) Provisional application No. 62/934,979, filed on Nov. 13, 2019.

(51) Int. Cl. G01N 27/12

(52) U.S. Cl. CPC G01N 27/127; G01N 27/122

(57) ABSTRACT

The techniques relate to methods and apparatus for determining data indicative of a concentration of an analyte in a fluid. First data indicative of a first property measurement of a first sensor while in fluid communication with the fluid is accessed. Second data indicative of a second property measurement of a second sensor in fluid communication with the fluid is accessed. A set of one or more parameters related to the first sensor, the second sensor, or both are accessed. The data indicative of the concentration of the analyte in the fluid is determined based on the first property measurement, the second property measurement, and the set of one or more parameters.

### RELATED APPLICATIONS

This Application claims priority under 35 U.S.C. § 119(e) to U.S. Provisional Application Ser. No. 62/934,979, filed Nov. 13, 2019 and entitled “NANOCHANNEL-BASED SENSOR CALIBRATION,” which is hereby incorporated by reference in its entirety.

### FIELD

The techniques described herein relate generally to methods and apparatus for nanochannel-based sensors used to sense chemical or biological species, and in particular to calibrating nanochannel-based sensors to sense a concentration of the chemical or biological species in a fluid.

### BACKGROUND OF INVENTION

Chemical or biological sensors can include nanowires and/or other small-scale electrical devices that essentially serve as sensitive transducers that convert chemical activity of interest into corresponding electrical signals that can be used to accurately represent the chemical activity. The nanosensors can include one or more nanowires (e.g., which may have a tubular form). The nanowires can be fabricated such that once functionalized, their surface will interact with adjacent molecular entities, such as chemical species. The interaction of the nanowires with molecular entities can induce a change in a property (such as conductance) of the nanowire.

### BRIEF SUMMARY OF INVENTION

For many sensing applications, it can be beneficial to employ sensors having high sensitivity to a species of interest. Sensors with high sensitivity can be used to detect much smaller amounts or concentrations of the species, which may be necessary or desirable in some applications, and/or such sensors can provide a high signal-to-noise ratio and thus improve the quality of measurements that are taken using the sensor.

In order for sensors to properly detect the amounts or concentrations of the species, the sensors need to be calibrated to take into account both various aspects that may affect sensor measurements, as well as to determine how to measure the concentration of an analyte in a solution based on available measurement data.

In some aspects, a computerized method for determining data indicative of a concentration of an analyte in a fluid is provided. The method includes accessing first data indicative of a first property measurement of a first sensor while in fluid communication with the fluid, accessing second data indicative of a second property measurement of a second sensor in fluid communication with the fluid, accessing a set of one or more parameters related to the first sensor, the second sensor, or both, and determining the data indicative of the concentration of the analyte in the fluid based on the first property measurement, the second property measurement, and the set of one or more parameters.

In some examples, the first sensor comprises one or more nanowires that are fabricated and functionalized to permit interaction with the analyte, and the second sensor comprises one or more reference nanowires that do not interact with the analyte.

In some examples, the first property measurement comprises a first conductance measurement and second property measurement comprises a second conductance measurement.

In some examples, accessing the set of one or more parameters comprises accessing a first parameter indicative of a measure of a sensitivity of the first sensor. The first sensor can include one or more nanowires that are fabricated and functionalized to permit interaction with the analyte, and the first parameter is indicative of a measure of a sensitivity of the one or more nanowires of the first sensor.

In some examples, accessing the set of one or more parameters comprises accessing a first parameter determined based on a third property measurement of the first sensor in communication with dry air, and a fourth property measurement of the second sensor in communication with dry air.

In some examples, accessing the set of one or more parameters comprises: accessing a third property measurement of the first sensor in communication with dry air, and a fourth property measurement of the second sensor in communication with dry air; and determining a first parameter based on the third property measurement and the fourth property measurement.

In some examples, accessing the set of one or more parameters comprises accessing: a first parameter indicative of a measure of a sensitivity of the first sensor, and a second parameter indicative of a parameter determined based on a third property measurement of the first sensor in communication with dry air and a fourth property measurement of the second sensor in communication with dry air; and determining the data indicative of the concentration of the analyte in the fluid comprises determining the data based on the first property measurement, the second property measurement, the first parameter, and the second parameter.

In some aspects, a system for determining data indicative of a concentration of an analyte in a fluid is provided. The system includes a memory storing instructions, and a processor configured to execute the instructions to perform accessing first data indicative of a first property measurement of a first sensor while in fluid communication with the fluid, accessing second data indicative of a second property measurement of a second sensor in fluid communication with the fluid, accessing a set of one or more parameters related to the first sensor, the second sensor, or both, and determining the data indicative of the concentration of the analyte in the fluid based on the first property measurement, the second property measurement, and the set of one or more parameters.

In some examples, the first sensor comprises one or more nanowires that are fabricated and functionalized to permit interaction with the analyte, and the second sensor comprises one or more reference nanowires that do not interact with the analyte.

In some examples, the first property measurement comprises a first conductance measurement and second property measurement comprises a second conductance measurement.

In some examples, accessing the set of one or more parameters comprises accessing a first parameter indicative of a measure of a sensitivity of the first sensor. The first sensor can include one or more nanowires that are fabricated and functionalized to permit interaction with the analyte, and the first parameter is indicative of a measure of a sensitivity of the one or more nanowires of the first sensor.

In some examples, accessing the set of one or more parameters comprises accessing a first parameter determined based on a third property measurement of the first sensor in communication with dry air, and a fourth property measurement of the second sensor in communication with dry air.

In some examples, accessing the set of one or more parameters comprises: accessing a third property measurement of the first sensor in communication with dry air, and a fourth property measurement of the second sensor in communication with dry air, and determining a first parameter based on the third property measurement and the fourth property measurement.

In some examples, accessing the set of one or more parameters comprises: accessing a first parameter indicative of a measure of a sensitivity of the first sensor, and a second parameter indicative of a parameter determined based on a third property measurement of the first sensor in communication with dry air and a fourth property measurement of the second sensor in communication with dry air; and determining the data indicative of the concentration of the analyte in the fluid comprises determining the data based on the first property measurement, the second property measurement, the first parameter, and the second parameter.

In some aspects, a non-transitory computer-readable media is provided. The non-transitory computer-readable media comprises instructions that, when executed by one or more processors on a computing device, are operable to cause the one or more processors to perform accessing first data indicative of a first property measurement of a first sensor while in fluid communication with the fluid, accessing second data indicative of a second property measurement of a second sensor in fluid communication with the fluid, accessing a set of one or more parameters related to the first sensor, the second sensor, or both, and determining the data indicative of the concentration of the analyte in the fluid based on the first property measurement, the second property measurement, and the set of one or more parameters.

In some examples, the first sensor comprises one or more nanowires that are fabricated and functionalized to permit interaction with the analyte, and the second sensor comprises one or more reference nanowires that do not interact with the analyte.

In some examples, the first property measurement comprises a first conductance measurement and second property measurement comprises a second conductance measurement.

In some examples, accessing the set of one or more parameters comprises accessing a first parameter indicative of a measure of a sensitivity of the first sensor.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 is a schematic diagram illustrating the use of a sensor device used to detect species in an analyte solution, according to some examples;

FIG. 2 (consisting of parts 2(a)-2(d)) depicts a nanochannel-based sensing element in the circuit of FIG. 1, according to some examples;

FIG. 3 depicts a sensor employing an array of nanochannels, according to some examples;

FIG. 4 is an exemplary graph showing the conductance of the sensors u and f for different measurements, according to some embodiments; and

FIG. 5 is a flow chart of an exemplary process to determine the concentration of a biomarker in a sample, according to some embodiments.

### DETAILED DESCRIPTION OF INVENTION

Nanochannel-based sensors can be used to detect an analyte in a liquid. The concentration of the analyte can be determined in a controlled environment based on various measurements, such as measurements taken of air, measurements taken using a blank liquid (without the analyte), and measurements taken using a test liquid that may (or may not) contain the analyte. However, the inventors have discovered and appreciated that the not all of those measurements may be available in practice, such as when testing devices are used at a user's home and/or in other environments outside of a controlled laboratory environment. For example, in practice, it may be undesirable and/or not be possible to obtain measurements using a test liquid. The inventors have developed improvements to existing nanochannel-based sensing technologies that can be used to calibrate nanochannel-based sensors so that the sensors can measure the concentration of the analyte using only the limited set of measurements that are likely available in practice.

In FIG. 1, a sensing element 10 is exposed to chemical or biological species(analyte) in an analyte solution 12. The sensing element 10 has connections to a bias/measurement circuit 14 that provides a bias voltage to the sensing element 10 and measures the differential conductance of the sensing element 10 (e.g., the small-signal change of conductance with respect to bias voltage). The differential conductance of the device is measured by applying a small modulation of bias voltage to generate a value of an output signal (OUT) that provides information about the chemical or biological species of interest in the analyte solution 12, for example a simple presence/absence indication or a multi-valued indication representing a concentration of the species in the analyte solution 12.

Suitable sensing elements (e.g., including semiconductor nanowires) and sensing technologies have been described in commonly-owned International Publication Number WO 2016/089,453, U.S. Pat. No. 10,378,044 and U.S. Publication No. 2014/0030747, each of which are incorporated herein by reference in their entireties.

The sensing element 12 includes one or more elongated conductors of a semiconductor material such as silicon, which may be doped with impurities to achieve desired electrical characteristics. The dimensions of a channel can be sufficiently small (e.g., nanoscale) such that chemical/electrical activity on the channel surface can have a much more pronounced effect on electrical operation than in larger devices. Such nanoscale channels may be referred to as nanochannels herein. In some embodiments, the sensing element 12 has one or more constituent nanochannels having a cross-sectional dimension of less than about 150 nm (nanometers), and even more preferably less than about 100 nm.

As described herein, the surface of the sensing element 12 can be functionalized by using a series of chemical reactions to incorporate receptors or sites for chemical interaction with the species of interest in the analyte solution 12. As a result of this interaction, the charge distribution, or surface potential, of the surface of the sensing element 12 changes in a corresponding manner. Such a change of surface potential can alter the conductivity of the sensing element 10 in a way that is detected and measured by the bias/measurement circuit 14. Thus, the sensing element 12 can operate as a field-effect device, since the channel conductivity can be affected by a localized electric field related to the surface potential or surface charge density. The measured differential conductance values can be converted into values representing the property of interest (e.g., the presence or concentration of species), based on known relationships as may have been established in a separate calibration procedure, for example.

FIG. 2 shows a sensing element 10 according to one example. As shown in the side view of FIG. 2(a), a silicon nanochannel 16 extends between a source (S) contact 18 and a drain (D) contact 20, all formed on an insulating oxide layer 22 above a silicon substrate 24. FIG. 2(b) is a top view showing the narrow elongated nanochannel 16 extending between the wider source and drain contacts 18, 20, which are formed of a conductive material such as gold-plated titanium for example. FIG. 2(c) shows the cross-sectional view in the plane C-C of FIG. 2(a). FIG. 2(d) shows the cross section of the nanochannel 16 in more detail. In the illustrated embodiment, the nanochannel 16 includes an inner silicon member 26 and an outer oxide layer 28 such as aluminum oxide.

FIG. 3 shows a sensing element 10 employing an array of nanochannels 16, which in the illustrated example are arranged into four sets 30, each set including approximately twenty parallel nanochannels 16 extending between respective source and drain contacts 18, 20. By utilizing arrays of nanochannels 16 such as shown, greater signal strength (current) can be obtained, which can improve the signal-to-noise ratio of the sensing element 10. To obtain fully parallel operation, the source contacts 18 are all connected together by separate electrical conductors, and likewise the drain contacts 20 are connected together by separate electrical conductors. Other configurations are of course possible. For example, each set 30 may be functionalized differently so as to react to different species which may be present in the analyte solution 12, enabling an assay-like operation. In such configurations, it should be understood that each set 30 has separate connections to the bias/measurement circuit 14 to provide for independent operation.

The sensing element 10 may be made by a variety of techniques employing generally known semiconductor manufacturing equipment and methods. In some embodiments, Silicon-on-Insulator (SOI) wafers are employed. A starting SOI wafer may have a device layer thickness of 100 nm and oxide layer thickness of 380 nm, on a 600 μm boron-doped substrate, with a device-layer volume resistivity of 10-20 Ω-cm. After patterning the nanochannel channels and the electrodes (e.g., in separate steps), the structure can be etched out with an anisotropic reactive-ion etch (RIE). This process can expose the three surfaces (top and sides) of the silicon nanochannels 16 along the longitudinal direction, resulting in increased surface-to-volume ratio. A layer of Al₂O₃ (e.g., approximately 5 to 15 nm thick) can be grown using atomic layer deposition (ALD). Selective response to specific biological or chemical species can be realized by fabricating the nanochannels 16 such that once functionalized, the nanochannels 16 react to one or more analytes. In use, a flow cell, such as a machined plastic flow cell, can be employed. For example, a machined plastic flow cell can be fitted to the device and sealed with silicone gel, with the sensing element 10 bathed in a fluid volume (of about 30 μL for example), connected to a syringe pump.

In some embodiments, the sensing element 10 may include other control elements or gates adjacent to the nanochannels 16. For example, the sensing element 10 can include a top gate, which can be a conductive element formed along the top of each nanochannel 16. Such a top gate may be useful for testing, characterization, and/or in some applications during use, to provide a way to tune the conductance of the sensing element in a desired manner. As another example, the sensing element 10 may include one or more side gates formed alongside each nanochannel 16 immediately adjacent to the oxide layer 28, which can be used for similar purposes as a top gate. As a further example, in some embodiments the sensing element 10 can include a temperature sensor (e.g., disposed near the nanochannels). The system can use measurements from the temperature sensor to modify the system operations. For example, the circuitry can be configured to adjust how the system maps measured nanowire conductances to the concentration of an analyte. Further details on nanochannel sensors can be found in, for example, U.S. Patent Publication No. 2014/0030747, entitled “Nanochannel-based sensor system for use in detecting chemical or biological species,” which is incorporated by reference herein in its entirety.

Various techniques can be used to detect and/or quantify the analyte using nanochannel sensors. Some examples include comparing measurements taken by a test sensor (a sensor fabricated such that once functionalized, the sensor is responsive to an analyte) and a reference sensor (a sensor that is fabricated such that even once functionalized, the sensor is not responsive to an analyte). For illustrative purposes, an example is described herein for an exemplary system that includes two silicon nanowire components, where sensor “u” is a reference sensor and serves as a reference, and sensor “f” is a test sensor with an antibody, and serves as the sensor that is used to measure for an analyte in a liquid. It should be appreciated that such a two sensor configuration is used for exemplary purposes only and is not intended to be limiting. For example, a device may only include one nanowire component (e.g., the test sensor) and use a different component as the reference (e.g., an electrode). As another example, a device may include a plurality of nanowire components, including a plurality of test nanowire sensors and/or a plurality of reference sensors.

FIG. 4 is an exemplary graph showing the conductance of the sensors u and f for different measurements, according to some embodiments. While this example is described in the context of conductance, it should be appreciated that other properties can be used in addition and/or alternatively, such as voltage, current, and/or the like. As shown, the conductance in air of the two components u and f are Gᵤ₀, G_{f0}, respectively. In some examples, nominally these two conductance measurements may be similar and/or may include small differences due to variances in the fabrication procedures (e.g., as shown in FIG. 4). The graph is not drawn to scale, and therefore an example of values with small variation for illustrative purposes is: Gᵤ₀=50 nS, and G_{f0}=55 nS.

In some environments (e.g., during manufacturing and/or in a laboratory) the two components can be first exposed to a blank serum without any biomarkers present. As shown in the graph, these conductances for u and f are G_{ub} and G_{fb}, respectively. Some serum (e.g., blood) may have a high salt content. Depending on the implementation, the dependence of the conductance on ionic strength may be a complicated nonlinear function. For illustrative purposes for this example, G_{ub}=100 nS, and G_{fb}=110 nS. The conductance can be a logarithmic function of the concentration of analyte molecules and ionic strength.

In operation (e.g., in the field, such as at a user's home) the two components can be exposed to the test liquid or serum, which can be a solution that may contain the biomarker of interest. As shown in FIG. 4, these conductances for u and f are Gᵤₛ, G_{fs}, respectively. The biomarker concentration can be low, e.g., when compared to the salt concentration in the serum. Depending on the implementation, the dependence of the conductance on biomarker concentration can be determined based on a linear function and/or near-linear function. For example, the concentration can be an approximation at low concentrations to the log-dependence predicted from the Poisson-Boltzmann equation. For the example shown in FIG. 4, Gᵤₛ=100 nS, and G_{fs}=115 nS.

The small concentration of the biomarker, Cm, can be proportional to G_{fs}-G_{fb} (e.g., in some environments, such as the laboratory). This is shown by Equation 1:

Cm=αf−(G_{fs}-G_{fb}) Equation 1

### Where:

αf is a measure of the sensitivity which can depend on aspects such as the geometry, preparation and environment of the test nanowire;
G_{fs} is the conductance for f when exposed to the test serum; and
G_{fb} is the conductance for f when exposed to a blank serum without any biomarkers present.

As shown in Equation 1, when both G_{fs}-G_{fb} are available, the reference sensor u is not needed as a reference for the concentration since assumptions can be made due to the linear relationship and zero offset. Additionally, since the concentration can be determined without needing to analyze the dependence of the conductance on ionic strength in a high salt serum, the relation between the nonlinear dependence of the conductance on ionic strength may not need to be determined.

While the various measurements shown in FIG. 4 can be used to calibrate nanochannel sensors and measure the concentration of an analyte, as described herein not all of the measurements described in conjunction with FIG. 4 may be available. For example, in some scenarios, it may not be possible to expose the sensors to both the blank serum and the test serum. For example, if employed in a device designed for use at a patient's home, it may not be possible to first expose the two components u and f to a blank serum. Therefore, the device may not have access to either G_{ub}, G_{fb}. Therefore, calculations such as that discussed in conjunction with Equation 1 that rely on G_{ub}, G_{fb} may not be available to determine the concentration of the of the biomarker (Cₘ).

In some embodiments, other data can be used to determine the concentration of the biomarker. For example, measurements available (e.g., without being able to use a blank serum) can include, for example, (i) the calibration coefficient of (e.g., which can be measured/estimated during and/or after fabrication, prior to delivery to a patient), (ii) the conductances in air Gᵤ₀, G_{f0}, and (iii) the conductances in blood with some unknown amount of biomarker Gᵤₛ, G_{fs}.

The techniques described herein can determine the concentration of the of the biomarker (Cₘ) without G_{fb}. FIG. 5 is a flow chart of an exemplary process to determine the concentration of a biomarker in a sample, according to some embodiments. The process can be executed by a device comprising and/or in communication with the sensors, such as the bias measurement circuit and/or other processing circuitry. At step 502, the device obtains measurements for a dry state of the sensors (e.g., in dry air). The device can access the measurements in memory and/or receive and/or determine the measurements based on signals from the sensors. For example, the device can use the sensors to measure both Gᵤ₀ and G_{f0}. The device can determine a metric based on the dry measurements. For example, the device can calculate the ratio of Equation 2:

β=G_{f0}/Gᵤ₀ Equation 2

At step 504, the device obtains and/or accesses measurements of the sensors exposed to a test serum that may contain the analyte. For example, the device can measure Gᵤₛ and G_{fs}.

At step 506, the device accesses one or more parameters related to the sensors. In some embodiments, one or more parameters can be used to relate the test serum measurements to other measurements. For example, one or more parameters can specify a relationship between the dry measurements obtained at step 502, the test measurements obtained at step 504 and/or the (unmeasured) measurements if the sensors were exposed to a test solution. For example, a parameter can specify a relationship between the ratio of G_{fb}/G_{ub} to G_{f0}/Gᵤ₀, such as G_{fb}/G_{ub}=β=G_{f0}/Gᵤ₀. As another example, one or more parameter can specify a relationship among different measurements of a particular sensor. For example, a parameter can specify that the reference sensor u does not change for a blank serum and test serum, such that G_{ub}=Gᵤₛ.

At step 508, the device determines the concentration of the analyte in the fluid based on the measurements from steps 502 and 504 and the parameters from step 506. In some embodiments, the device can use a formula to use to determine the concentration of the of the biomarker (Cₘ). As an illustrative example, depending on the parameters, one exemplary formula can be Equation 3:

Cₘ=α_{f}(G_{fs}-βGᵤₛ) Equation 3

While Equation 3 shows an example of a linear solution, other techniques can be used instead of and/or in addition to linear mappings. For example, other techniques that can be used include (a) a polynomial in G_{fs} (and possibly Gᵤₛ), (b) a lookup table for mapping G_{fs} (e.g., and Gᵤₛ) to a concentration value, (c) using a temperature measurement to refine the concentration mappings as described herein, and/or the like. The parameters of the solutions used to determine the analyte concentration can be determined and/or obtained using various techniques. For example, one or more of the parameters of the mapping functions can be obtained from physics, from data obtained from characterizing a series of devices (e.g., in the lab and/or in the field), and/or the like.

In some embodiments, the techniques used to detect the concentration of the analyte (e.g., using Equation 3) can be confirmed or validated as described herein. For example, a model of the dependence of the conductance dependence on surface charge density can be used to determine the parameters and/or to validate the formula used to determine the concentration. In some scenarios (e.g., desired conditions at zero bias) the sensitivity S of the nanosensor response (relative change in conductance when charge is added) can be determined as shown in Equation 4:

$$S = \frac{Δ G}{{G}_{0}} = ( \frac{{l}_{eff}}{{A}_{eff}} ) \frac{{n}_{s}}{{N}_{D}} ≡ \frac{{n}_{s}}{{a}_{eff} {N}_{D}} \qquad Equation 4$$

### Where:

ΔG is the change in conductance when a particular nanowire sensor has some charge added to the surface;
G₀ is a geometric factor;
l_{eff} is the effective length of the nanowire, such as the circumference of a cylindrical nanowire of radius a, which can be computed by l_{eff}=2πa;
A_{eff}is the effective cross-sectional area of the nanowire, which for a cylindrical nanowire can be computed by A_{eff}=πa²;
nₛ is the number density of unitary charges absorbed on the surface of the nanowire (e.g., the charge per unit area/|qₑ|);
a_{eff} is an inverse effective length parameter that parameterizes (l_{eff}/A_{eff}); and
N_{D} is the total doping (e.g., charge carriers per unit volume).

In some examples, the geometric factor is a ratio of the nominal perimeter (e.g., the circumference of a cylindrical nanowire of radius l_{eff}=2πa) to the cross-sectional area A_{eff}=πa² (and has units of 1/Length (1/a for the cylinder)). The effective length and/or effective area can be related to not only the nanowire geometry, but also include other aspects, such as dielectric properties, external gate potentials, etc. For example, such other aspects can be obtained by solving an equation such as the nonlinear Poisson-Boltzmann equation.

In some examples, the surface charge comes from point charges on molecules that are bound to the surface, in equilibrium with molecules in solution. The relations provided in Equation 4 can be useful for validating the techniques used to determine the concentration, e.g., because it can be intuitively evident that the sensitivity (e.g., relative conductance) should simply be related to the ratio of the surface charge to the bulk volume charge in the nanowire (e.g., so long as it is recognized that the effective length parameter can include gate potentials and more complicated effects).

In some embodiments, when a serum with an unknown amount of biomarker is added, the conductances of both the reference and test nanosensors may change. For example, the reference nanosensor may change due to salt, proteins that bind non-specifically, and/or due to temperature. The surface charge density may be a function of a number of variables yᵢ, i=1, 2, etc. Because of the high salt environment, the functional dependence can also be a nonlinear function. The change in conductance can be referred to as gᵤₛ(y₁, y₂, . . . ). Therefore, the conductance Gᵤₛ can be expressed as shown below in Equation 5:

Gᵤₛ=Gᵤ₀+gᵤₛ(y₁, y₂, . . . ) Equation 5

As another example, the test nanosensor may change because of salt, proteins that bind non-specifically, and/or temperature, as well as the biomarker that can bind to the antibodies immobilized on the surface. The surface charge density may therefore not only be a function of a complicated number of variables yᵢ, i=1, 2, etc. but also the biomarker concentration Cₘ. Since Cₘ may be small, it can be viewed as simply additive and linear. The change in conductance can be referred to as gᵤₛ(y₁, y₂, . . . ). Therefore, the conductance G_{fs} can be expressed as shown below in Equation 6:

G_{fs}=G_{f0}+g_{fs}(y₁, y₂, . . . )+Cₘ/α_{f} Equation 6

In some examples, referring to Equations 5 and 6, typically g_{fs} is not equal to gᵤₛ. However, g_{fs} may be related to gᵤₛ. For example, as described herein, a parameter can specify G_{f0}/Gᵤ₀=β, which can be measured in advance. In some examples, when the concentration of the biomarker is zero, then Cₘ=0 and G_{fs}=G_{fb}. In some examples, Gᵤₛ=G_{ub} since the reference sensor will respond the same in serum either with or without the biomarker.

If G_{f0}/Gᵤ₀=β, then Equation 7 below can follow:

$$\frac{{G}_{fs}}{{G}_{us}} = \frac{{G}_{f 0} + {g}_{fs} ( y ) + {C}_{m} / {α}_{f}}{{G}_{u 0} + {g}_{us}} = β + {C}_{m} / ( {α}_{f} {G}_{us} ) \qquad Equation 7$$

Equation 7 demonstrates that the solution specified by Equation 3 holds, and therefore the concentration can be obtained by measuring Gᵤ₀, Gᵤₛ, Gₛ₀, G_{sb} and knowing the calibration coefficient α_{f}.

A parameter that specifies a relation of G_{f0} to Gᵤ₀, such as G_{f0}/Gᵤ₀=β, can assume that the surface binding sites in blood for salt ions or other non-specific binding is greater (e.g., significantly greater) than the number of antibodies on the surface. When designing test nanowires, it can be desirable to cover the nanowire with as great a density of antibodies as possible. Therefore, at first blush it may seem that the surface binding sites in blood for salt ions or other non-specific binding is not necessarily greater than the number of antibodies on the surface. However, since antibodies are larger than the surface binding sites in the oxide layer, the assumption can still hold. Some embodiments can further include making multiple sets of nanowire sensors (e.g., two sets, or more), with different effective lengths and/or a different number of parallel sensors with similar properties, such as a similar putative width, and assuming uniform functionalization and uniform cross-section.

In some embodiments, a nonlinear Poisson-Boltzmann equation analysis can be used to verify nanowire response. A difference between a FET and a BioFET can include that in a FET, the electric field and associated conductance in the channel can be obtained by solving an electrostatic equation with given surface potential V, set by a gate voltage (e.g., Dirichlet boundary conditions). In a BioFET, the electric field can be obtained by solving a similar electrostatic equation for a FET, but with a fixed surface charge density σ=δV/δz at the nanowire surface (e.g., Neumann boundary conditions). Changes in the surface charge density due to binding of a biomarker can be proportional to the concentration of the biomarker in solution. Other than that, a BioFET can be analyzed similarly to a MOSFET.

In some embodiments, reference sensor measurements may not be used and/or available. Therefore, in some embodiments, the concentration of the analyte can be determined using just a test sensor. For example, the conductance of the functionalized sensor, G_{f}, can be periodically and/or constantly measured as it transitions from G_{f0} to G_{fs} (e.g., as shown in FIG. 3). While G_{fb} is unavailable and/or not used, the system can approximate G_{fb} with an intermediate value, G_{fx}, which is the conductance just when the test serum (e.g., blood with the marker) is applied to the sensors. The system need not know exactly when the test serum is applied, since it can be determined by periodically and/or constantly monitoring the conductance of the test sensor.

Various computer systems can be used to perform any of the aspects of the techniques and embodiments disclosed herein. The computer system may include one or more processors and one or more non-transitory computer-readable storage media (e.g., memory and/or one or more non-volatile storage media) and a display. The processor may control writing data to and reading data from the memory and the non-volatile storage device in any suitable manner, as the aspects of the invention described herein are not limited in this respect. To perform functionality and/or techniques described herein, the processor may execute one or more instructions stored in one or more computer-readable storage media (e.g., the memory, storage media, etc.), which may serve as non-transitory computer-readable storage media storing instructions for execution by the processor.

In connection with techniques described herein, code used to, for example, provide the techniques described herein may be stored on one or more computer-readable storage media of computer system. Processor may execute any such code to provide any techniques for planning an exercise as described herein. Any other software, programs or instructions described herein may also be stored and executed by computer system. It will be appreciated that computer code may be applied to any aspects of methods and techniques described herein. For example, computer code may be applied to interact with an operating system to plan exercises for diabetic users through conventional operating system processes.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

Various aspects are described in this disclosure, which include, but are not limited to, the above-described aspects.

What is claimed is:

1. A computerized method for determining data indicative of a concentration of an analyte in a fluid, the method comprising:
accessing first data indicative of a first property measurement of a first sensor while in fluid communication with the fluid;
accessing second data indicative of a second property measurement of a second sensor in fluid communication with the fluid;
accessing a set of one or more parameters related to the first sensor, the second sensor, or both; and
determining the data indicative of the concentration of the analyte in the fluid based on the first property measurement, the second property measurement, and the set of one or more parameters.

2. The computerized method of claim 1, wherein:
the first sensor comprises one or more nanowires that are fabricated and functionalized to permit interaction with the analyte; and
the second sensor comprises one or more reference nanowires that do not interact with the analyte.

3. The computerized method of claim 1, wherein the first property measurement comprises a first conductance measurement and second property measurement comprises a second conductance measurement.

4. The computerized method of claim 1, wherein accessing the set of one or more parameters comprises accessing a first parameter indicative of a measure of a sensitivity of the first sensor.

5. The computerized method of claim 4, wherein:
the first sensor comprises one or more nanowires that are fabricated and functionalized to permit interaction with the analyte; and
the first parameter is indicative of a measure of a sensitivity of the one or more nanowires of the first sensor.

6. The computerized method of claim 1, wherein accessing the set of one or more parameters comprises accessing a first parameter determined based on:
a third property measurement of the first sensor in communication with dry air; and
a fourth property measurement of the second sensor in communication with dry air.

7. The computerized method of claim 1, wherein accessing the set of one or more parameters comprises:
accessing:
a third property measurement of the first sensor in communication with dry air; and
a fourth property measurement of the second sensor in communication with dry air; and
determining a first parameter based on the third property measurement and the fourth property measurement.

8. The computerized method of claim 1, wherein:
accessing the set of one or more parameters comprises accessing:
a first parameter indicative of a measure of a sensitivity of the first sensor; and
a second parameter indicative of a parameter determined based on a third property measurement of the first sensor in communication with dry air and a fourth property measurement of the second sensor in communication with dry air; and
determining the data indicative of the concentration of the analyte in the fluid comprises determining the data based on the first property measurement, the second property measurement, the first parameter, and the second parameter.

9. A system for determining data indicative of a concentration of an analyte in a fluid, the system comprising a memory storing instructions, and a processor configured to execute the instructions to perform:
accessing first data indicative of a first property measurement of a first sensor while in fluid communication with the fluid;
accessing second data indicative of a second property measurement of a second sensor in fluid communication with the fluid;
accessing a set of one or more parameters related to the first sensor, the second sensor, or both; and
determining the data indicative of the concentration of the analyte in the fluid based on the first property measurement, the second property measurement, and the set of one or more parameters.

10. The system of claim 9, wherein:
the first sensor comprises one or more nanowires that are fabricated and functionalized to permit interaction with the analyte; and
the second sensor comprises one or more reference nanowires that do not interact with the analyte.

11. The system of claim 9, wherein the first property measurement comprises a first conductance measurement and second property measurement comprises a second conductance measurement.

12. The system of claim 9, wherein accessing the set of one or more parameters comprises accessing a first parameter indicative of a measure of a sensitivity of the first sensor.

13. The system of claim 12, wherein:
the first sensor comprises one or more nanowires that are fabricated and functionalized to permit interaction with the analyte; and
the first parameter is indicative of a measure of a sensitivity of the one or more nanowires of the first sensor.

14. The system of claim 9, wherein accessing the set of one or more parameters comprises accessing a first parameter determined based on:
a third property measurement of the first sensor in communication with dry air; and
a fourth property measurement of the second sensor in communication with dry air.

15. The system of claim 9, wherein accessing the set of one or more parameters comprises:
accessing:
a third property measurement of the first sensor in communication with dry air; and
a fourth property measurement of the second sensor in communication with dry air; and
determining a first parameter based on the third property measurement and the fourth property measurement.

16. The system of claim 9, wherein:
accessing the set of one or more parameters comprises accessing:
a first parameter indicative of a measure of a sensitivity of the first sensor; and
a second parameter indicative of a parameter determined based on a third property measurement of the first sensor in communication with dry air and a fourth property measurement of the second sensor in communication with dry air; and
determining the data indicative of the concentration of the analyte in the fluid comprises determining the data based on the first property measurement, the second property measurement, the first parameter, and the second parameter.

17. A non-transitory computer-readable media comprising instructions that, when executed by one or more processors on a computing device, are operable to cause the one or more processors to perform:
accessing first data indicative of a first property measurement of a first sensor while in fluid communication with the fluid;
accessing second data indicative of a second property measurement of a second sensor in fluid communication with the fluid;
accessing a set of one or more parameters related to the first sensor, the second sensor, or both; and
determining the data indicative of the concentration of the analyte in the fluid based on the first property measurement, the second property measurement, and the set of one or more parameters.

18. The non-transitory computer-readable media of claim 17, wherein:
the first sensor comprises one or more nanowires that are fabricated and functionalized to permit interaction with the analyte; and
the second sensor comprises one or more reference nanowires that do not interact with the analyte.

19. The non-transitory computer-readable media of claim 17, wherein the first property measurement comprises a first conductance measurement and second property measurement comprises a second conductance measurement.

20. The non-transitory computer-readable media of claim 17, wherein accessing the set of one or more parameters comprises accessing a first parameter indicative of a measure of a sensitivity of the first sensor.
